(19) United States
(12) Patent Application Publication
(10) Pub. No.: US 2003/0154960 A1
(43) Pub. Date: Aug. 21, 2003

(54) Hold-down metal plate for securing a fuel injection valve

(76) Inventors: Juergen Krome, Schlangen (DE); Ferdinand Reiter, Markgroeningen (DE); Jens Pohlmann, Schwieberdingen (DE)

Correspondence Address: KENYON & KENYON, ONE BROADWAY, NEW YORK, NY, 10004, US

(21) Appl. No.: 10/258,321

(22) PCT Filed: Feb. 21, 2002
(86) PCT No.: PCT/DE02/00643

(30) Foreign Application Priority Data
Feb. 21, 2001 (DE) 101 08 190.1

(51) Int. Cl. F02M 61/14

(52) U.S. Cl. 123/470

(57) ABSTRACT

A holding down plate for fastening a fuel injector in a location orifice of a cylinder head of a mixture-compressing internal combustion engine includes on one end a fastening bore (2), which is penetrated by a fastening element which fastens the holding down plate (1) to the cylinder head, and the opposite end of the holding down plate (1) has a location orifice (3) for receiving a fuel injector, the location orifice (3) being divided by an insertion recess (4) and delimited by a first and a second fork end (6, 7), which exert a force on the fuel injector thereby pressing the fuel injector against a pressure shoulder located in the location orifice of the cylinder head. The first and the second fork end (6, 7) are bent in a shape that is undulated in cross-section and is oriented toward the fuel injector, a radius (R2) of the undulated bending each forming a support area (13, 14).

### BACKGROUND INFORMATION

The present invention is directed to a holding down plate for fastening of a fuel injector according to the definition of the species in the main claim.

For receiving a fuel injector, direct-injection internal combustion engines usually have a location bore in a cylinder head in which a pressure shoulder is formed, against which the fuel injector is pressed using a clamping claw or a holding down plate. Such a clamping claw is known from Unexamined Japanese Patent Application 08-31 25 03.

Due to the non-symmetry of the applied force, transverse forces occur in the fuel injector, resulting in stresses which may cause interference and even failure of the system during operation of the fuel injector.

### ADVANTAGES OF THE INVENTION

The holding down plate according to the present invention having the characterizing features of the main claim has the advantage over the related art in that the force is applied symmetrically due to the bent fork ends. The force is applied along a support line which is symmetrical with regard to the longitudinal axis of the fuel injector.

According to the measures recited in the subclaims, advantageous refinements of the holding down plate according to the present invention are possible.

The linear support areas of the bent fork ends lie on a common straight line, so that the holding down plate may be oriented in any desired way with regard to a symmetrically designed fuel injector. By introducing a slot which starts at the location orifice it is possible to produce two independently formed bending bars whose elasticity determines the support force in the support area. By introducing the slot asymmetrically, it is further possible to influence the spring constant of the particular bending bar according to the length of the bending bars up to the support area, so that the same force is always applied to the fuel injector in the support area. Thereby the introduction of transverse forces into the fuel injector can be prevented. The spring-elastic fork ends make an axial length compensation possible. Thus tolerances occurring during manufacture as well as the elongation due to temperature differences occurring during operation can be compensated for.

### DRAWING

An exemplary embodiment of a holding down plate according to the present invention is illustrated in the drawing in simplified form and is explained in greater detail in the following description.

FIG. 1 shows a top view of a holding down plate according to the present invention; and

FIG. 2 shows a side view of a holding down plate according to the present invention from FIG. 1.

### DESCRIPTION OF THE EXEMPLARY EMBODIMENT

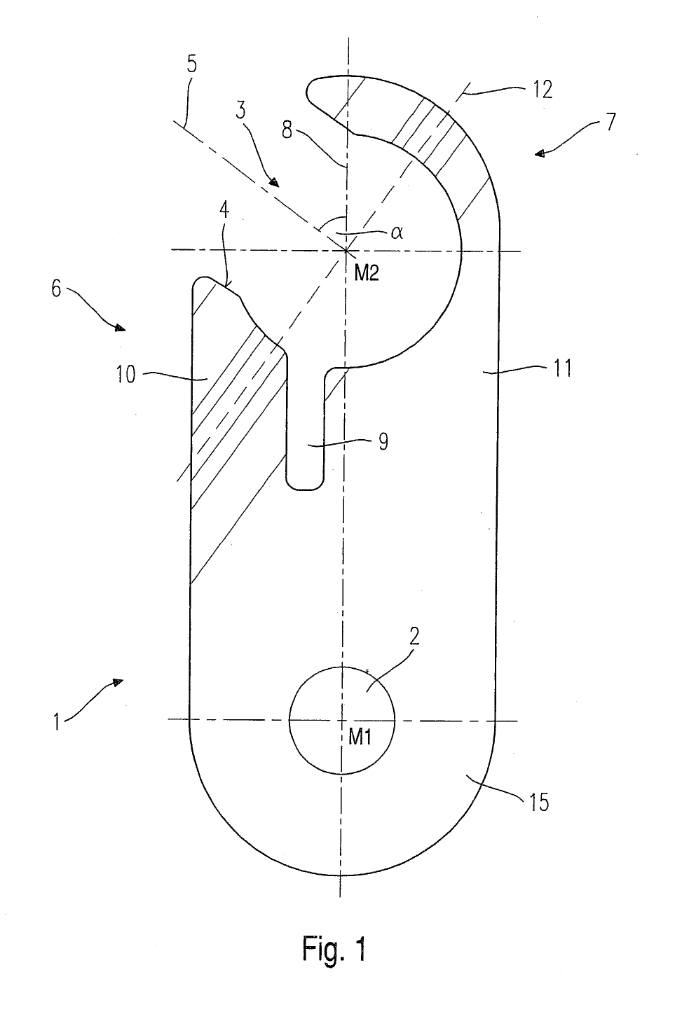

A holding down plate 1 is illustrated in FIG. 1 in a top view. Holding down plate 1 has essentially an oblong basic geometry, both small faces being semicircularly rounded. At one end holding down plate 1 has a fastening bore 2, whose center MI is identical to the center of the semicircular rounding. Fastening bore 2 is used for receiving a fastening means, a screw for example, which is screwed into the cylinder head (not shown) and thereby securing holding down plate 1.

A location orifice 3 is introduced into holding down plate 1 at the diametrically opposed end of holding down plate 1; the center M2 of location orifice 3 is also situated on longitudinal axis 8 of holding down plate 1. In order to simplify the assembly, location orifice 3 has an insertion recess 4, whose center line 5 runs through center M2 of location orifice 3. Center line 5 of insertion recess 4 forms an insertion angle α which is different from zero with longitudinal axis 8 of holding down plate 1. Insertion recess 4 makes it possible to install holding down plate 1 even when the fuel line is installed. Insertion angle α is determined by the amount of space available on the particular engine.

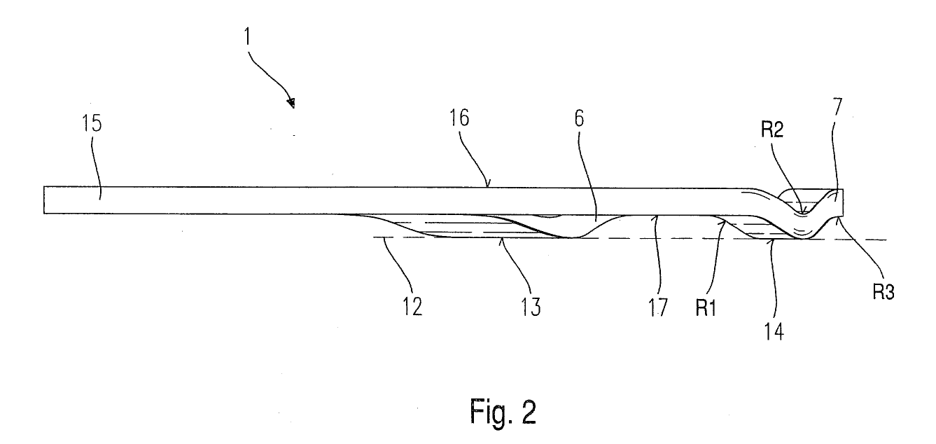

According to the position of center line 5 of insertion recess 4 the injector-side end of holding down plate 1 is divided in a bifurcate manner and forms a first fork end 6 and a second fork end 7. First fork end 6 and second fork end 7 have different lengths, whose relationship depends on the width of insertion recess 4 and the position of center line 5 of insertion recess 4. First fork end 6 and second fork end 7 are bent so that each forms a support line, which have a common connecting line 12, which runs through center M2 of location orifice 3 and preferably forms a right angle with center line 5 of insertion recess 4. Center M2 of location orifice 3 coincides with the longitudinal axis of the fuel injector (not shown) which is perpendicular to the drawing plane. The design of bent fork ends 6 and 7 is described below on the basis of FIG. 2.

In order to prevent stresses in the fuel injector, it is necessary to provide the same pressure force by both fork ends 6 and 7. To achieve this, a slot 9 is introduced into holding down plate 1, the slot starting from location orifice 3 being situated, for example, parallel to longitudinal axis 8 of holding down plate 1. Slot 9 divides holding down plate 1 into a first bending bar 10 and a second bending bar 11. The spring characteristic curves of first bending bar 10 and second bending bar 11 are determined by the distance of slot 9 from longitudinal axis 8 of holding down plate 1 as well as the width and length of slot 9. The spring parameters of first bending bar 10 and second bending bar 11 are set such that the forces introduced into the fuel injector by first fork end 6 and second fork end 7 are the same. This makes it possible to compensate for the effect of the varying length of the bending lengths of first fork end 6 and second fork end 7.

For clarification of the bending profile of bent fork ends 6 and 7, holding down plate 1 is illustrated in FIG. 1 in a side view. Both fork ends 6 and 7 are preferably shaped jointly so that they have an identical profile which will be explained on the basis of second fork end 7. The shape of both fork ends 6 and 7 is described by three radii. Starting from the sides of a flat section 15, with which holding down plate 1 is fastened on a fastening face of the cylinder head, fork end 7 is bent in the direction of fuel injector side 17 of holding down plate 1, with a first radius R1. Subsequently, second fork end 7 is bent in the opposite direction with radius R2, ending after a radius R3, which is oriented as first radius R1, i.e., again on the level of flat section 15. Thus, a flat face results on side 16 facing away from the fuel injector. At least radius R1 and third radius R3 are preferably equal, and the bending lines of the three radii R1 through R3 run parallel to one another. The two support areas 13 and 14 are formed on fuel injector side 17 of second radius R2.

If first fork end 6 and second fork end 7 are shaped jointly, the first support area 13 and second support area 14 will be automatically situated on a straight line 12. Hereby, connecting straight line 12 runs parallel to fuel injector side 17 of holding down plate 1. Support areas 13 and 14 of fork ends 6 and 7 may be oriented so that they run neither parallel nor at a right angle to longitudinal axis 8 of holding down plate 1. Fork ends 6 and 7 may be designed asymmetrically.

Holding down plate 1 may be cost-effectively manufactured as a punched bending part, for example. An axial tolerance compensation of the fuel injector is made possible by using spring-elastic fork ends 6 and 7.

what is claimed is:

1. A holding down plate for fastening a fuel injector in a location orifice of a cylinder head of a mixture-compressing internal combustion engine, the holding down plate (1) having at one end a fastening bore (2), which is penetrated by a fastening element which fastens the holding down plate (1) to the cylinder head, and the opposite end of the holding down plate (1) having a location orifice (3) for receiving a fuel injector, the location orifice (3) being divided by an insertion recess (4) and delimited by a first and a second fork end (6, 7), which exert a force on the fuel injector, pressing the fuel injector against a pressure shoulder located in the location bore of the cylinder head, and the first and second fork end (6, 7) each being bent in a shape which is undulated in cross-section and is oriented toward the fuel injector and each radius (R2) of the undulated bending forming a support area (13, 14).

2. The holding down plate as recited in claim 1, wherein the first and second support areas (13, 14) of the two fork ends (6, 7) are situated on a common connecting straight line (12).

3. The holding down plate as recited in claim 2, wherein the connecting straight line (12) has a point of intersection with the longitudinal axis of the fuel injector.

4. The holding down plate as recited in one of claims 2 or 3, wherein the connecting straight line (12) is perpendicular to the normal of the holding down plate (1) plane.

5. The holding down plate as recited in one of claims 1 through 4, wherein the support areas (13, 14) are perpendicular to a center line (5) of the insertion recess (4).

6. The holding down plate as recited in one of claims 1 through 5, wherein a slot (9) is introduced into the holding down plate (1) starting from the location orifice (3), the slot being positioned asymmetrically with respect to a longitudinal axis (8) of the holding down plate (1) and forming a bending bar (10, 11) for each fork end (6, 7).

7. The holding down plate as recited in claim 6, wherein due to the asymmetry of the bending bars (10, 11) the different bending lengths of the fork ends (6, 7) are compensatable so that the forces transmitted to the fuel injector in the support areas (13, 14) are identical for both fork ends (6, 7).

8. The holding down plate as recited in one of claims 2 through 7, wherein the support areas (13, 14) of the fork ends (6, 7) are oriented so that they run neither parallel nor at a right angle to a longitudinal axis (8) of the holding down plate (1).

9. The holding down plate as recited in one of the preceding claims, wherein the fork ends (6, 7) are asymmetrical.
